(19) United States
(12) Patent Application Publication
(10) Pub. No.: US 2017/0258017 A1
(43) Pub. Date: Sep. 14, 2017

(54) Collapsible Horizontal Trellis

(71) Applicant: Phillip M. Scaletta, Valencia, CA (US)

(72) Inventor: Phillip M. Scaletta, Valencia, CA (US)

(21) Appl. No.: 15/453,374

(22) Filed: Mar. 8, 2017

Related U.S. Application Data
(60) Provisional application No. 62/305,296, filed on Mar. 8, 2016.

(51) Int. Cl. A01G 9/12; F16M 11/32; F16M 11/38; A01G 13/02; A01G 17/06

(52) U.S. Cl. CPC A01G 9/12; A01G 13/0206; A01G 17/06; F16M 11/38; F16M 11/32; F16M 2200/08

(57) ABSTRACT

A collapsible and portable trellis which supports growing plants and increases their overall yield. The trellis includes a first half assembly, a second half assembly, and a locking mechanism. The first half assembly and the second half assembly are hingedly connected to each other through the locking mechanism and each includes a first lateral beam, a second lateral beam, a first crossbar, a second crossbar, a lattice, and an at least one support leg. The first lateral beam and the second lateral beam are positioned parallel and offset to each other. The first crossbar and the second crossbar are perpendicularly connected in between the first lateral beam and the second lateral beam to yield an overall rectangular shape. The support leg is connected to the second crossbar. The lattice is mounted to the first lateral beam, the second lateral beam, the first crossbar, and the second crossbar.

The current application claims a priority to the U.S. Provisional Patent application Ser. No. 62/305,296 filed on Mar. 8, 2016.

### FIELD OF THE INVENTION

The present invention relates generally to the field of indoor and outdoor growing of plants. More specifically, the present invention is a collapsible and portable trellis for indoor and outdoor plant growing.

### BACKGROUND OF THE INVENTION

Traditionally, a trellis net has been used for plant growing, where the net keeps the plants from falling over during the growing process and keeps the canopy even. The issue with using netting is that most individuals have to build the frame themselves. This requires effort, time, money, knowledge, and labor. Moreover, as plants grow and expand they get tangled and held up in the trellis netting. In addition, the traditional trellis net can only be used for a particular growing purpose. For varied growing purposes requiring various grid sizes, an individual would require multiple trellis nets since the grid in the net cannot be changed. Using multiple nets for growing is time consuming and labor intensive. In most previous devices in the field of the present invention, growing is limited to the area provided by the frame or trellis net. Limited growing space results in the individual having to utilize extra growing space for additional growing. In some cases, such as indoor growing, using additional space for plant growing can be stressful and at times not possible. Furthermore, most previous plant support systems lack the ability to be stored away when not in use. The inability to be stored results in the support system consuming valuable space. Additionally, traditional methods and devices are limited to either indoor growing or for outdoor growing. Growing area limitations can be a disadvantage for the individual in terms of effort, time and labor.

The objective of the present invention is to address the aforementioned issues an individual might encounter in the growing process. The present invention may be used in a variety of different industries including, but not limited to, hydroponic industry, tomato growing industries and other plant growing industries that require lateral support. The present invention is a horizontal trellis that can be assembled with minimum effort and knowledge. Additionally, the present invention provides a method for increasing growth and yield. More specifically, the method includes the individual wrapping the plant around the rigid lattice of the present invention such that other nodes are exposed to light, thus increases the overall yield. Furthermore, the structure of the present invention allows an individual to customize the grid size and height of the horizontal trellis, whereas traditional netting only provides a fixed size gridding. The height adjustable aspect of the present invention allows the individual to accommodate to various plant sizes. Because the present invention is collapsible, the space required to store the present invention is relatively small compared to traditional methods and devices. Thus, the present invention ultimately makes the growing and harvesting of plants easier and more efficient.

### BRIEF DESCRIPTION OF THE DRAWINGS

FIG. 1 is a perspective view of the present invention positioned in a functional configuration.

FIG. 2 is an exploded view of a first half assembly of the present invention, indicating the location, orientation, and mounting means for the a plurality of first rods and plurality of second rods.

FIG. 3 is a perspective view of the present invention depicting one of the steps necessary to position the present invention into a collapsed configuration.

FIG. 4 is a perspective view of the present invention depicting one of the steps necessary to position the present invention into a collapsed configuration.

FIG. 5 is a perspective view of the present invention positioned into the collapsed configuration.

### DETAIL DESCRIPTIONS OF THE INVENTION

All illustrations of the drawings are for the purpose of describing selected versions of the present invention and are not intended to limit the scope of the present invention.

The present invention generally relates to horticulture equipment and devices. More specifically, the present invention is a collapsible horizontal trellis that can be assembled, disassembled, and stored with minimum effort and experience. The present invention provides a rigid guide and support structure for growing a wide variety of plants that is easy to manipulate, store, and transport. Contrary to traditional net-based trellises, the guide and support grid of the present invention utilizes elongated rigid structures. This allows the user to wrap the growing plants around the rigid structures in order to expose other nodes underneath to light, thus increasing the overall growth and yield. Additionally, this allows the user to customize the grid size and height of the present invention.

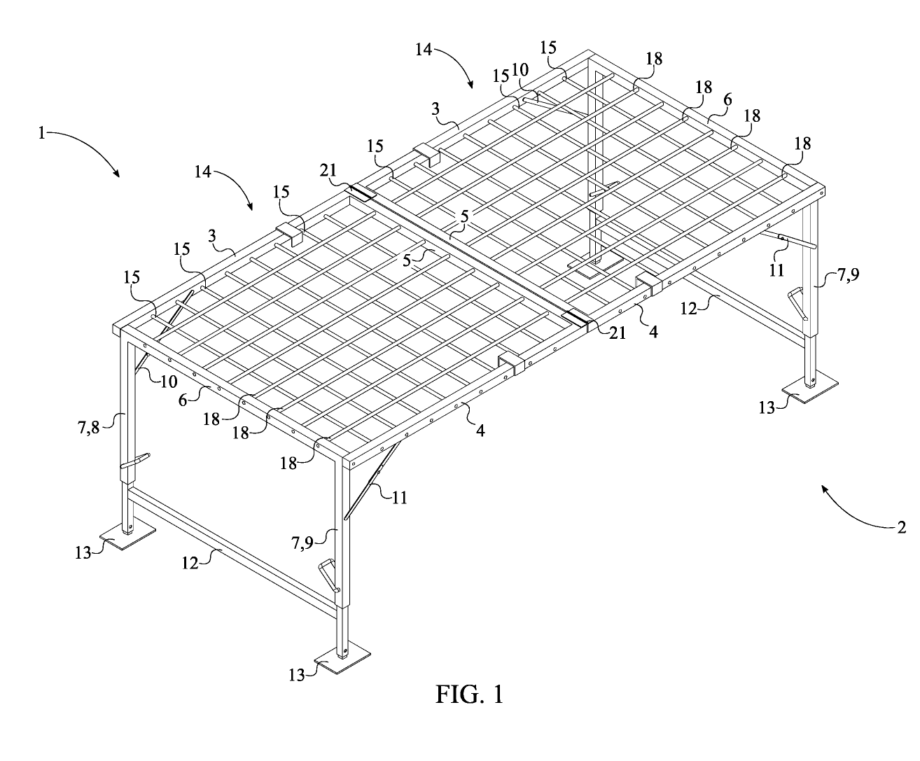

Referring to FIG. 1, the present invention comprises a first half assembly 1, a first half assembly 2, and an at least one locking mechanism 21. The first half assembly 1 and the first half assembly 2 each make up half of the horizontal trellis and are hingedly connected together to allow for easy and quick assembly and disassembly. The first half assembly 1 and the first half assembly 2 each comprise a first lateral beam 3, a second lateral beam 4, a first crossbar 5, a second crossbar 6, a lattice 14, and an at least one support leg 7. The first lateral beam 3, the second lateral beam 4, the first crossbar 5, and the second crossbar 6 are each an elongated support structure with a preferred square cross-section. The first lateral beam 3, the second lateral beam 4, the first crossbar 5, and the second crossbar 6 make up the horizontal frame which supports and elevates the lattice 14. More specifically, the first lateral beam 3 and the second lateral beam 4 are equal in length and are positioned parallel and offset to each other. To produce a rectangular-shaped frame, the first crossbar 5 and the second crossbar 6 are equal in length and are positioned parallel and opposite to each other across the first lateral beam 3 and the second lateral beam 4. The first crossbar 5 rigidly connects the first lateral beam 3 and the second lateral beam 4, thus is perpendicularly connected in between the first lateral beam 3 and the second lateral beam 4. Similarly, the second crossbar 6 rigidly connects the first lateral beam 3 and the second lateral beam 4; in particular, the second crossbar 6 is perpendicularly and rotatably connected in between the first lateral beam 3 and the second lateral beam 4.

The support leg 7 bears the weight of the present invention and keeps the present invention upright. The support leg 7 is terminally connected to the second crossbar 6. As a result, the support leg 7 is able to rotate with the second crossbar 6 relative to the first lateral beam 3, the second lateral beam 4, and the first crossbeam. This allows the support beam to rotate and fold relative to the horizontal frame, ideal for storage and transportation. The shape, design, and size of the support leg 7 is subject to change in order to accommodate the needs and preferences of the plants being grown within the present invention. The first half assembly 1 and the first half assembly 2 are connected to each other by a hinge, thus allowing for the present invention to be collapsed into a relatively small profile. More specifically, the first crossbar 5 of the first half assembly 1 is positioned adjacent and parallel to the first crossbar 5 of the first half assembly 2. Additionally, the first crossbar 5 of the first half assembly 1 is hingedly connected to the first crossbar 5 of the first half assembly 2. This allows the first half assembly 1 and the first half assembly 2 to be positioned into a collapsed configuration and a functional configuration. The locking mechanism 21 secures the present invention into either the collapsed configuration or the functional configuration. In particular, the locking mechanism 21 is mechanically integrated in between the first crossbar 5 of the first half assembly 1 and the first crossbar 5 of the first half assembly 2. In the preferred embodiment of the present invention, the locking mechanism 21 is an at least one locking hinge. A variety of designs may be used for the locking hinge.

The lattice 14 is rigid structure used to support plants during growth. The lattice 14 is a grid/mesh composed of a multitude of rigid poles. The lattice 14 creates growing paths for a multitude of individual plants and prevents adjacent plants from falling and applying pressure onto each other. The lattice 14 eliminates the need to purchase nettings repeatedly, thus saving money for the user. The lattice 14 is positioned adjacent and parallel to the first lateral beam 3, the second lateral beam 4, the first crossbar 5, and the second crossbar 6. Additionally, the lattice 14 is perimetrically attached to the first lateral beam 3, the second lateral beam 4, the first crossbar 5, and the second crossbar 6. A variety of means may be used to attach the lattice 14. In general, the lattice 14 covers the area in between the first lateral beam 3, the second lateral beam 4, the first crossbar 5, and the second crossbar 6.

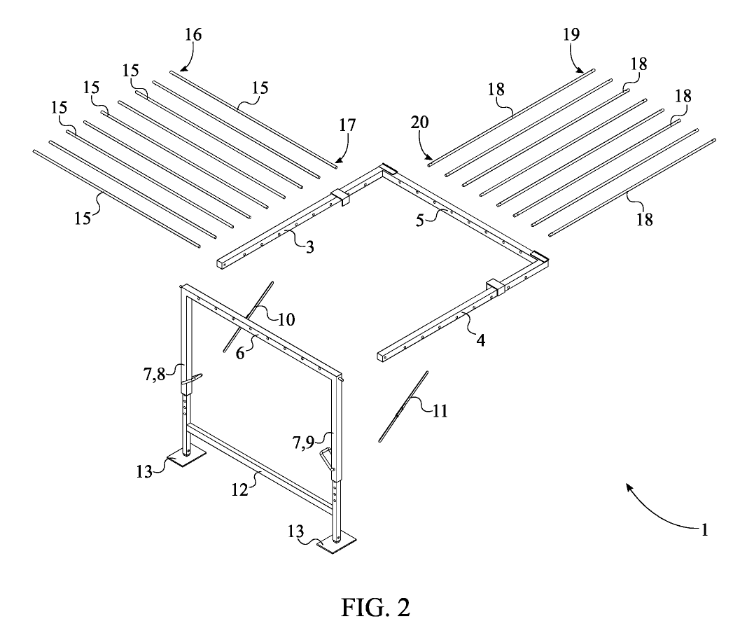

Referring to FIG. 1 and FIG. 2, in the preferred embodiment of the present invention, the lattice 14 comprises a plurality of first rods 15 and a plurality of second rods 18. The plurality of first rods 15 and the plurality of second rods 18 are identical in design, shape, length, and size. Each of the plurality of first rods 15 is an elongated rigid rod spanning the distance between the first lateral beam 3 and the second lateral beam 4, preferably composed of a plastic material. In alternative embodiments of the present invention, each of the plurality of first rods 15 is composed of a rust-resistant light metal, for example aluminum. More specifically, the plurality of first rods 15 is distributed along the first lateral beam 3 with each of the plurality of first rods 15 being oriented perpendicular to the first lateral beam 3. A first end 16 of each of the plurality of first rods 15 is attached to the first lateral beam 3 Similarly, a second end 17 of each of the plurality of first rods 15 is attached to the second lateral beam 4. This is achieved through a first plurality of attachment mechanisms and a second plurality of attachment mechanisms. Each of the first plurality of attachment mechanisms comprises a first hole, a first spring-loaded detent, and the first end 16 of a corresponding rod, wherein the corresponding rod is one of the plurality of first rods 15. The first hole traverses through the first lateral beam 3 and receives the first end 16 of the corresponding rod. The first spring-loaded detent is a locking mechanism 21 that is laterally integrated into the first end 16 of the corresponding rod. The first spring-loaded detent is essentially a ball supported by a spring which may rise and lower under the presence of force. In order to attach the first end 16 of the corresponding rod to the first lateral beam 3, the first end 16 of the corresponding rod is positioned within the first hole; and, the first hole is engaged by the first spring-loaded detent. In order to disengage, the user simply pulls the first end 16 of the corresponding rod out of the first hole; the pulling force applies a vertical force onto the first spring-loaded detent, thus depressing the ball and disengaging the first spring-loaded detent.

In a similar fashion, each of the second plurality of attachment mechanisms comprises a second hole, a second spring-loaded detent, and the second end 17 of a corresponding rod, wherein the corresponding rod is one of the plurality of first rods 15. The second hole traverses through the second lateral beam 4 and receives the second end 17 of the corresponding rod. The second spring-loaded detent is a locking mechanism 21 that is laterally integrated into the second end 17 of the corresponding rod. The second spring-loaded detent is essentially a ball supported by a spring which may rise and lower under the presence of force. In order to attach the second end 17 of the corresponding rod to the second lateral beam 4, the second end 17 of the corresponding rod is positioned within the second hole; and, the second hole is engaged by the second spring-loaded detent. In order to disengage, the user simply pulls the second end 17 of the corresponding rod out of the second hole; the pulling force applies a vertical force onto the second spring-loaded detent, thus depressing the ball and disengaging the second spring-loaded detent.

In one embodiment of the present invention, the attachment mechanism is a simple threaded engagement. For the plurality of first rods 15, the first end 16 of each of the plurality of first rods 15 is positioned within a receiving hole of the first lateral beam 3 and is threadably engaged to the first lateral beam 3. The second end 17 of each of the plurality of first rods 15 is positioned within a receiving hole of the second lateral beam 4. To attach or detach, the user simply rotates the rod body to engage or disengage the threaded connection.

Each of the plurality of second rods 18 is an elongated rigid rod spanning the distance between the first crossbar 5 and the second crossbar 6, preferably composed of a plastic material. In alternative embodiments of the present invention, each of the plurality of first rods 18 is composed of a rust-resistant light metal, for example aluminum. More specifically, the plurality of second rods 18 is distributed along the first crossbar 5 with each of the plurality of second rods 18 being oriented perpendicular to the first crossbar 5. This orients each of the plurality of second rods 18 perpendicular to each of the plurality of first rods 15, thus composing the grid/mesh design. The plurality of second rods 18 is marginally and vertically offset from the plurality of first rods 15. The rectangular spaces of the resulting grid/mesh receive and support growing plants, thus creating a trellis. A first end 19 of each of the plurality of second rods 18 is attached to the first crossbar 5. Similarly, a second end 20 of each of the plurality of second rods 18 is attached to the second crossbar 6. This is achieved through a third plurality of attachment mechanisms and a fourth plurality of attachment mechanisms. Each of the third plurality of attachment mechanisms comprises a third hole, a third spring-loaded detent, and the first end 19 of a corresponding rod, wherein the corresponding rod is one of the plurality of second rods 18. The third hole traverses through the first crossbar 5 and receives the first end 19 of the corresponding rod. The third hole is vertically offset from the first hole and the second hole in order ensure that the plurality of first rods 15 and the plurality of second rods 18 are vertically offset and able to overlap in order to produce the grid/mesh. The third spring-loaded detent is a locking mechanism 21 that is laterally integrated into the first end 19 of the corresponding rod. The third spring-loaded detent is essentially a ball supported by a spring which may rise and lower under the presence of force. In order to attach the first end 19 of the corresponding rod to the first crossbar 5, the first end 19 of the corresponding rod is positioned within the third hole; and, the third hole is engaged by the third spring-loaded detent. In order to disengage, the user simply pulls the first end 19 of the corresponding rod out of the third hole; the pulling force applies a vertical force onto the third spring-loaded detent, thus depressing the ball and disengaging the third spring-loaded detent.

In a similar fashion, each of the fourth plurality of attachment mechanisms comprises a fourth hole, a fourth spring-loaded detent, and the second end 20 of a corresponding rod, wherein the corresponding rod is one of the plurality of second rods 18. The fourth hole traverses through the second crossbar 6 and receives the second end 20 of the corresponding rod. The fourth hole is vertically offset from the first hole and the second hole in order ensure that the plurality of first rods 15 and the plurality of second rods 18 are vertically offset and able to overlap in order to produce the grid/mesh. The fourth spring-loaded detent is a locking mechanism 21 that is laterally integrated into the second end 20 of the corresponding rod. The fourth spring-loaded detent is essentially a ball supported by a spring which may rise and lower under the presence of force. In order to attach the second end 20 of the corresponding rod to the second crossbar 6, the second end of the corresponding rod is positioned within the fourth hole; and, the fourth hole is engaged by the fourth spring-loaded detent. In order to disengage, the user simply pulls the second end 20 of the corresponding rod out of the fourth hole; the pulling force applies a vertical force onto the fourth spring-loaded detent, thus depressing the ball and disengaging the fourth spring-loaded detent.

In one embodiment of the present invention, the attachment mechanism is a simple threaded engagement. For the plurality of second rods 18, the first end 19 of each of the plurality of second rods 18 is positioned within a receiving hole of the first crossbar 5 and is threadably engaged to the first crossbar 5. The second end 20 of each of the plurality of second rods 18 is positioned within a receiving hole of the second crossbar 6. To attach or detach, the user simply rotates the rod body to engage or disengage the threaded connection.

During the harvesting process, the removable aspect of the plurality of first rods 15 and the plurality of second rods 18 facilitate the physical removal of plants from the lattice 14.

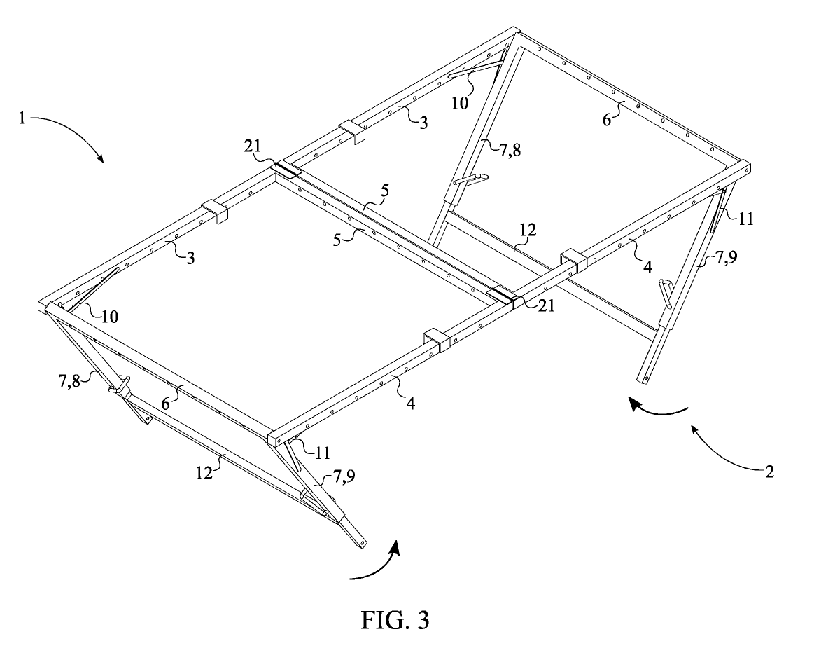

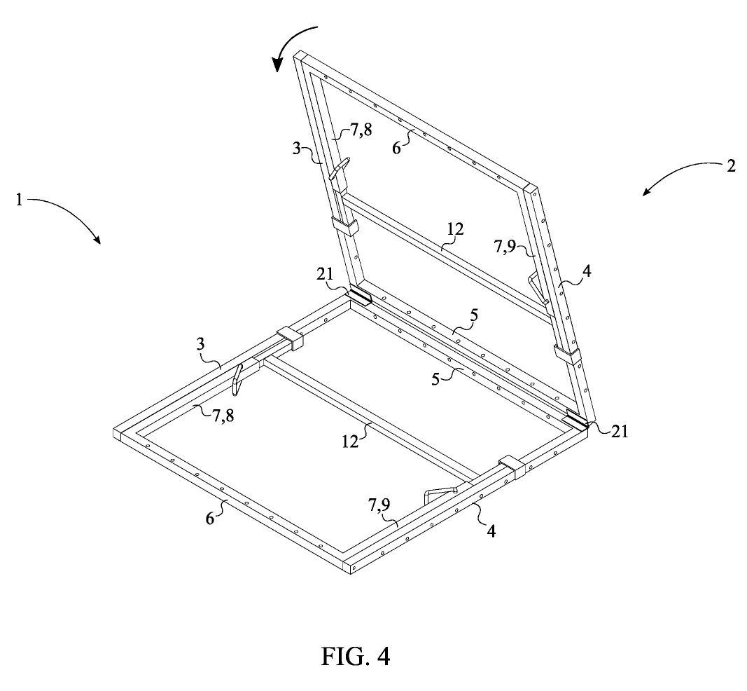

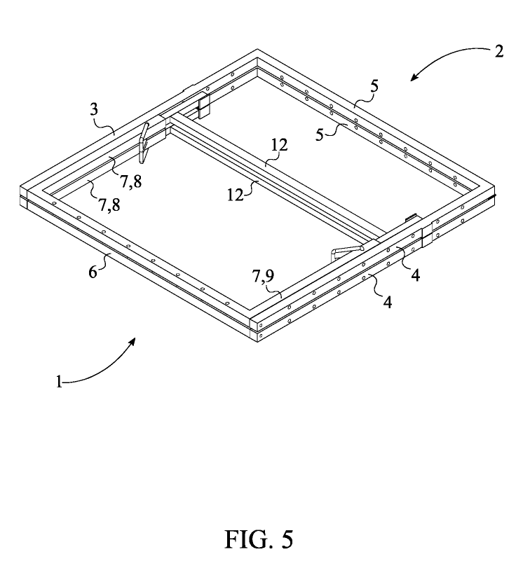

Referring to FIG. 1 and FIG. 5, the present invention may be positioned into two configurations, the collapsed configuration and the functional configuration. When the first half assembly 1 and the first half assembly 2 are configured into the collapsed configuration, the overall profile of the present invention is reduced. The reduced profile allows for easy transportation and storage. To position the present invention into the collapsed configuration, the plurality of first rods 15 and the plurality of second rods 18 of the first half assembly 1 and the first half assembly 2 are first removed. Next, the support leg 7 is positioned in between the first lateral beam 3 and the second lateral beam 4, parallel to the first lateral beam 3; this is executed for both the first half assembly 1 and the first half assembly 2 as seen in FIG. 3 and FIG. 4. Finally, the first lateral beam 3 of the first half assembly 1 is positioned adjacent and parallel to the first lateral beam 3 of the first half assembly 2 as seen in FIG. 4 and FIG. 5. This essentially folds the present invention along a sagittal plane, thus reducing the overall profile. To position the present invention into the functional configuration, the support leg 7 is first positioned perpendicular to the first lateral beam 3. Then, the first lateral beam 3 of the first half assembly 1 is positioned collinear with the first lateral beam 3 of the first half assembly 2. This positions the lattice 14 of the first half assembly 1 and the lattice 14 of the first half assembly 2 in a horizontal orientation. The present invention is secured in the functional configuration by the locking mechanism 21.

Referring to FIG. 1, the first half assembly 1 and the first half assembly 2 each further comprise an at least one interchangeable foot 13. The interchangeable foot 13 allows the user to place the present invention on a variety of ground conditions. The interchangeable foot 13 is positioned adjacent to the support leg 7, opposite the second crossbar 6. Additionally, the interchangeable foot 13 is terminally attached to the support leg 7. The interchangeable foot 13 is attached through a pin-slot method. Although, alternative mechanisms may also be utilized. In one embodiment, the interchangeable foot 13 includes a mounting stake which allows the user to drive the support leg 7 into the ground for additional security. In one embodiment, the interchangeable foot 13 includes a rolling wheel which allows the user to easily move the present invention without disassembly. In one embodiment, the interchangeable foot 13 includes a flat panel which allows the user to evenly place and orient the present invention on level ground. The shape of the flat panel may vary to further increase the versatility of the present invention. For example, the flat panel may be L-shaped in order to allow the present invention to be placed in a corner of a garden, or at a corner of a building/structure. Thus, the present invention can fit over or fit inside most grow trays. In another embodiment, the present invention may be mounted on a wall through the use of the flat panel and a plurality of fastening mechanisms.

In the preferred embodiment of the present invention, the at least one support leg 7 comprises a first telescoping leg 8 and a second telescoping leg 9. The first telescoping leg 8 and the second telescoping leg 9 are positioned opposite to each other, across the second crossbar 6. The first telescoping leg 8 and the second telescoping leg 9 are oriented parallel to each other for symmetrical stability. This design provides adequate stability for the present invention under a variety of weather conditions, ensuring the present invention is secure in the upright position. Additionally, the first telescoping leg 8 and the second telescoping leg 9 allow the user to easily vary the height of the horizontal frame and thus the lattice 14. A variety of technologies may be used to achieve the telescoping aspect of the first telescoping leg 8 and the second telescoping leg 9. The preferred method includes the first telescoping leg 8 and the second telescoping leg 9 each comprising two tubular bodies that are slidably engaged to each other. Each of the tubular bodies includes a plurality of holes which receive a pin lock. The pin lock allows the user to secure the two tubular bodies at a specific configuration, i.e. length. Furthermore, the first half assembly 1 and the first half assembly 2 each further comprise a transverse beam 12. The transverse beam 12 rigidly connects the first telescoping leg 8 and the second telescoping leg 9. In particular, the transverse beam 12 is perpendicularly connected in between the first telescoping leg 8 and the second telescoping leg 9.

To further secure the present invention in the functional configuration, the first half assembly 1 and the first half assembly 2 each further comprise a first hinged counterfort 10 and a second hinged counterfort 11. The first hinged counterfort 10 and the second hinged counterfort 11 ensure the first telescoping leg 8 and the second telescoping leg 9 are locked and secured perpendicular to the first lateral beam 3 when the present invention is positioned into the functional configuration. More specifically, the first hinged counterfort 10 is mechanically integrated between the first telescoping leg 8 and the first lateral beam 3. Similarly, the second hinged counterfort 11 is mechanically integrated between the second telescoping leg 9 and the second lateral beam 4.

Referring to FIG. 4 and FIG. 5, in the preferred embodiment of the present invention, the first half assembly 1 and the first half assembly 2 each further comprise a first leg-receiving bracket and a second leg-receiving bracket. The first leg-receiving bracket is a U-shaped structure shaped and sized to receive the first telescoping leg 8 when the present invention is positioned into the collapsed configuration. The first leg-receiving bracket is positioned in between the first lateral beam 3 and the second lateral beam 4. Additionally, the first leg-receiving bracket is laterally connected to the first lateral beam 3. Similarly, the second leg-receiving bracket is a U-shaped structure shaped and sized to receive the second telescoping leg 9 when the present invention is positioned into the collapsed configuration. The second leg-receiving bracket is positioned in between the first lateral beam 3 and the second lateral beam 4. Additionally, the second leg-receiving bracket is laterally connected to the second lateral beam 4. When the present invention is positioned into the collapsed configuration, the first telescoping leg 8 is positioned within the first leg-receiving bracket and the second telescoping leg 9 is positioned within the second leg-receiving bracket. This ensures that the first telescoping leg 8 and the second telescoping leg 9 do not move and unfold while the present invention is being transported.

Additionally, in the preferred embodiment, the first lateral beam 3, the second lateral beam 4, the first crossbar 5, the second crossbar 6, the support leg 7, and the lattice 14 are all composed of a plastic material

Although the invention has been explained in relation to its preferred embodiment, it is to be understood that many other possible modifications and variations can be made without departing from the spirit and scope of the invention as hereinafter claimed.

What is claimed is:

1. A collapsible horizontal trellis comprises:
a first half assembly;
a second half assembly;
an at least one locking mechanism;
the first half assembly and the second half assembly each comprise a first lateral beam, a second lateral beam, a first crossbar, a second crossbar, and an at least one support leg;
the first lateral beam and the second lateral beam being positioned parallel and offset to each other;
the first crossbar and the second crossbar being positioned parallel and opposite to each other across the first lateral beam and the second lateral beam;
the first crossbar being perpendicularly connected in between the first lateral beam and the second lateral beam;
the second crossbar being perpendicularly and rotatably connected in between the first lateral beam and the second lateral beam;
the support leg being terminally connected to the second crossbar;
the first crossbar of the first half assembly being positioned adjacent and parallel to the first crossbar of the second half assembly;
the first crossbar of the first half assembly being hingedly connected to the first crossbar of the second half assembly; and
the locking mechanism being mechanically integrated in between the first crossbar of the first half assembly and the first crossbar of the second half assembly.

2. The collapsible horizontal trellis as claimed in claim 1 comprises:
wherein the first half assembly and the second half assembly are configured into a functional configuration;
the first half assembly and the second half assembly each further comprise a lattice;
the support leg being positioned perpendicular to the first lateral beam;
the first lateral beam of the first half assembly being positioned collinear with the first lateral beam of the second half assembly;
the lattice being positioned adjacent and parallel to the first lateral beam, the second lateral beam, the first crossbar, and the second crossbar; and
the lattice being perimetrically attached to the first lateral beam, the second lateral beam, the first crossbar, and the second crossbar.

3. The collapsible horizontal trellis as claimed in claim 2 comprises:
the lattice comprises a plurality of first rods and a plurality of second rods;
the plurality of first rods being distributed along the first lateral beam;
each of the plurality of first rods being oriented perpendicular to the first lateral beam;
a first end of each of the plurality of first rods being attached to the first lateral beam;
a second end of each of the plurality of first rods being attached to the second lateral beam;
the plurality of second rods being distributed along the first crossbar;
each of the plurality of second rods being oriented perpendicular to the first crossbar;
a first end of each of the plurality of second rods being attached to the first crossbar; and
a second end of each of the plurality of second rods being attached to the second crossbar.

4. The collapsible horizontal trellis as claimed in claim 1 comprises:
the at least one support leg comprises a first telescoping leg and a second telescoping leg;
the first half assembly and the second half assembly each further comprise a transverse beam;
the first telescoping leg and the second telescoping leg being positioned opposite to each other, across the second crossbar;
the first telescoping leg and the second telescoping leg being oriented parallel to each other; and
the transverse beam being perpendicularly connected in between the first telescoping leg and the second telescoping leg.

5. The collapsible horizontal trellis as claimed in claim 4 comprises:
the first half assembly and the second half assembly each further comprise a first hinged counterfort and a second hinged counterfort;
the first hinged counterfort being mechanically integrated between the first telescoping leg and the first lateral beam; and
the second hinged counterfort being mechanically integrated between the second telescoping leg and the second lateral beam.

6. The collapsible horizontal trellis as claimed in claim 1 comprises:
the first half assembly and the second half assembly each further comprise an at least one interchangeable foot;
the interchangeable foot being positioned adjacent to the support leg, opposite the second crossbar; and
the interchangeable foot being terminally attached to the support leg.

7. The collapsible horizontal trellis as claimed in claim 1 comprises:
wherein the first half assembly and the second half assembly are configured into a collapsed configuration;
the support leg being oriented parallel to the first lateral beam;
the support leg being positioned in between the first lateral beam and the second lateral beam; and
the first lateral beam of the first half assembly being positioned adjacent and parallel to the first lateral beam of the second half assembly.

8. The collapsible horizontal trellis as claimed in claim 1, wherein the at least one locking mechanism is a locking hinge.

9. A collapsible horizontal trellis comprises:
a first half assembly;
a second half assembly;
an at least one locking mechanism;
the first half assembly and the second half assembly each comprise a first lateral beam, a second lateral beam, a first crossbar, a second crossbar, a lattice, and an at least one support leg;
the first lateral beam and the second lateral beam being positioned parallel and offset to each other;
the first crossbar and the second crossbar being positioned parallel and opposite to each other across the first lateral beam and the second lateral beam;
the first crossbar being perpendicularly connected in between the first lateral beam and the second lateral beam;
the second crossbar being perpendicularly and rotatably connected in between the first lateral beam and the second lateral beam;
the support leg being terminally connected to the second crossbar;
the first crossbar of the first half assembly being positioned adjacent and parallel to the first crossbar of the second half assembly;
the first crossbar of the first half assembly being hingedly connected to the first crossbar of the second half assembly;
the locking mechanism being mechanically integrated in between the first crossbar of the first half assembly and the first crossbar of the second half assembly;
the lattice being positioned adjacent and parallel to the first lateral beam, the second lateral beam, the first crossbar, and the second crossbar; and
the lattice being perimetrically attached to the first lateral beam, the second lateral beam, the first crossbar, and the second crossbar.

10. The collapsible horizontal trellis as claimed in claim 9 comprises:
wherein the first half assembly and the second half assembly are configured into a functional configuration;
the support leg being positioned perpendicular to the first lateral beam; and
the first lateral beam of the first half assembly being positioned collinear with the first lateral beam of the second half assembly.

11. The collapsible horizontal trellis as claimed in claim 9 comprises:
the lattice comprises a plurality of first rods and a plurality of second rods;
the plurality of first rods being distributed along the first lateral beam;
each of the plurality of first rods being oriented perpendicular to the first lateral beam;
a first end of each of the plurality of first rods being attached to the first lateral beam;
a second end of each of the plurality of first rods being attached to the second lateral beam;
the plurality of second rods being distributed along the first crossbar;
each of the plurality of second rods being oriented perpendicular to the first crossbar;
a first end of each of the plurality of second rods being attached to the first crossbar; and
a second end of each of the plurality of second rods being attached to the second crossbar.

12. The collapsible horizontal trellis as claimed in claim 9 comprises:
the at least one support leg comprises a first telescoping leg and a second telescoping leg;
the first half assembly and the second half assembly each further comprise a transverse beam;
the first telescoping leg and the second telescoping leg being positioned opposite to each other, across the second crossbar;
the first telescoping leg and the second telescoping leg being oriented parallel to each other; and
the transverse beam being perpendicularly connected in between the first telescoping leg and the second telescoping leg.

13. The collapsible horizontal trellis as claimed in claim 12 comprises:
the first half assembly and the second half assembly each further comprise a first hinged counterfort and a second hinged counterfort;
the first hinged counterfort being mechanically integrated between the first telescoping leg and the first lateral beam; and
the second hinged counterfort being mechanically integrated between the second telescoping leg and the second lateral beam.

14. The collapsible horizontal trellis as claimed in claim 9 comprises:
the first half assembly and the second half assembly each further comprise an at least one interchangeable foot;
the interchangeable foot being positioned adjacent to the support leg, opposite the second crossbar; and
the interchangeable foot being terminally attached to the support leg.

15. The collapsible horizontal trellis as claimed in claim 9, wherein the at least one locking mechanism is a locking hinge.
